(19) United States
(12) Patent Application Publication
(10) Pub. No.: US 2009/0305554 A1
(43) Pub. Date: Dec. 10, 2009

(54) Adjustable Patch Panel and Methods of Using Same

(76) Inventor: Frank S. Siano, Suwanee, GA (US)

Correspondence Address: NORA M. TOCUPS, P.O BOX 698, 140 PINECREST AVE, DECATUR, GA, 30030, US

(21) Appl. No.: 12/306,915

(22) PCT Filed: Jun. 28, 2007
(86) PCT No.: PCT/US07/72403

§ 371 Date: Dec. 29, 2008

Related U.S. Application Data
(60) Provisional application No. 60/806,121, filed on Jun. 29, 2006.

(51) Int. Cl. H01R 13/60

(52) U.S. Cl. 439/540.1

(57) ABSTRACT

An adjustable patch panel that may allow access to its back by movement of the panel's arms. An exemplary patch panel includes two panels releasably and flexibly connected to each other collinearly to fit a rack of a first size. One and/or both panels may have an opening for one or more cabling connectors. A mounting means on each panel may be flexibly connected to its panel. The flexible connection of each mounting means to its panel allows the panel to be selectively pivoted about a vertical axis of the mounting means and allows adjustment of the flexibly connected panels into a non-collinear position to fit a rack of another size. The flexible connection between the panels and the flexible connection of each mounting means to its panel allows use of the patch panel with different size racks, and allows separation of the panels for back access to the panels.

### CROSS-REFERENCE TO RELATED APPLICATION

The present application claims priority to and benefit of the prior filed co-pending and commonly owned provisional application, filed in the United States Patent and Trademark Office on Jun. 29, 2006, assigned Ser. No. 60/806,121, and incorporated herein by reference.

### FIELD OF THE INVENTIONS

The inventions relate generally to cable management devices for network equipment racks. Particularly, the inventions relate to patch panels as may be used with such racks and to methods of using such patch panels.

### BACKGROUND

Rack systems with patch panels are often used to manage cables and their connections. These systems usually include the standard EIA 19″, 23″ or other distribution frame rack on which one or more patch panels, network equipment, fiber optic enclosures, and/or the like may be mounted. A rack typically has a patching side where patch cords from active and other devices may be cross-connected and interconnected. The other side of the rack is typically the distribution side where cables from network equipment, work stations, and the like may be terminated.

Patch panels are described or referenced in the following patents: Morgan et al., U.S. Pat. No. 5,129,842, Standish, et al. U.S. Pat. No. 6,600,106, Barker et al. U.S. Pat. No. 6,866,541; and Barker et al., U.S. Pat. No. 6,918,786. Other patents describing devices that may be in the general field include: Puetz, U.S. Pat. No. 5,734,776; Orlando, U.S. Pat. No. 5,788,087; Ott et al., U.S. Pat. No. 5,945,633; Falkenberg et al. U.S. Pat. No. 6,240,234; Bartolutti et al. U.S. Pat. No. 6,350,148; and Caveney, U.S. Pat. No. 6,614,978. These patents are incorporated herein by reference.

### SUMMARY

Stated generally, the inventions include an adjustable patch panel, a patch panel with back access, and an adjustable patch panel with back access.

A first exemplary patch panel is adjustable and allows back access. This patch panel includes two panels that are of substantially the same size and shape. The panels are releasably and flexibly connected to each other in a generally collinear position. With its panels in this collinear position, the exemplary patch panel may be made to fit a rack of a first size such as a “23” inch rack. The releasable and flexible connection between the panels may be accomplished by a connector such as a hinge, (which may be made of any appropriate material), and/or such as sufficiently flexible material (or combination of material) such as leather, rubber, or plastic. One and/or both panels may have an opening for one or more cabling connectors.

To fit the exemplary patch panel on a rack, a mounting means such as a mounting plate may be used. In this example, a mounting means is flexibly connected by a mounting means connector to each panel. The mounting means of each panel may be positioned opposite to that panel's connection to the other panel. A mounting means connector may be a hinge, or flexible material such as leather, rubber, or plastic. The flexible connection of each mounting means to its panel may allow the panel to be selectively pivoted about a vertical axis of the mounting means. The flexible connection of each mounting means to its respective panel may also allow adjustment of the flexibly connected panels into a non-collinear position to fit a rack of another size such as a “19” inch rack. Advantageously, the flexible connection between the panels and the flexible connection of each mounting means to its respective panel allows use of the exemplary patch panel with different size racks, and allows for separation of the panels for back access to the panels.

Another exemplary embodiment is a patch panel with back access. This exemplary patch panel includes two arms. A first arm includes at least one opening for a cable connector. One end of the first arm is attached by an end connector to a mounting plate. The end connector allows the first arm to swing at least partially and generally perpendicularly about the vertical axis of the end connector. A second arm of the patch panel is mountable in a position substantially collinear with the first arm. To achieve this collinear position, an end of the second arm is positioned generally adjacent to the unattached end of the first arm. In the embodiment described in this paragraph, a user may swing the first arm away from its collinear position adjacent the second arm. By opening the first arm, the user may have access to the back of that arm.

In another exemplary embodiment, the user may have access to the back of both arms of a patch panel. This double arm access embodiment may be constructed generally as described in the immediately preceding paragraph with some additions. In the double arm access embodiment, the second arm also is attached by an end connector to a mounting plate. Thus, the end connector allows the second arm to swing at least partially and generally perpendicularly about the vertical axis of the end connector. Thus, a user may have access to the back of the second arm as well as the first.

In either of the two embodiments described in the two previous paragraphs, the first arm may be releasably connected to the second arm. This releasable connection may be accomplished by using a hinge between the two arms. To swing either the first or second arm away from the other, an arm is released from its connection to the other arm. Also, the first arm may be flexibly connected to the second arm so that the arms may be adjusted from the substantially collinear position to another position so as to fit a rack of a different size.

Another exemplary embodiment of the inventions includes a panel that may be adjusted to fit racks (and/or other elements) of different sizes. The panel of this example includes a first arm flexibly connected to a second arm. By this flexible connection, the arms of the exemplary panel are mountable to a rack in a position selected from available positions. Such positions may include a first position where the connected arms are collinear with respect to their horizontal axes, and a second position where the connected arms share a horizontal plane, but are angled with respect to each other. This second position may include the first arm substantially perpendicularly positioned with respect to the second arm. One or both arms may include one or more cable connectors. Further, the first arm may be releasably as well as flexibly connected to the second arm so that the first arm is movable away from the second arm.

The adjustable panel of the previous paragraph may include a first mounting element connected to the first arm. The connection may be made generally opposite to the first arm's flexible connection to the second arm. Similarly, a second mounting element may be connected to the second arm generally opposite to the second arm's flexible connection to the first arm. Both mounting elements are flexibly connected to their respective arms so as to allow the connected arms to be mounted to the rack in the selected position. The flexible connection between the first and second arms and the flexible connection of the mounting elements to their respective arms allow the adjustable panel to be mounted in a position selected from the more than one available positions.

A particular advantage of the inventions is that they may be adjusted so as to provide a patch panel that may be made to fit racks of various sizes, including standard sizes. Advantageously this adjustment may be made by the user as he or she is installing one or more of the adjustable patch panels. In other words, the user does not have to have patch panels of various sizes on hand to fit different sizes of racks, but may use the invention as an adjustable patch panel for many different sizes of racks. Thus, the user does not have to carry a large inventory of patch panels of varying sizes, nor does the user have to transport patch panels of varying sizes to the job site. Using an adjustable patch panel of the invention may allow the user to reduce inventory and save on overhead, and may also reduce inventory transported and used at a job site, thereby simplifying and streamlining the installation process. Details regarding the adjustability of the exemplary adjustable patch panel 10 are provided below. Advantageously, a user does not have to purchase two different sizes of patch panels for use with racks of various sizes. Rather, a user may purchase or use just one size of adjustable patch panel such as provided by the exemplary embodiment, and be assured the adjustable patch panel will fit racks of various sizes.

Another particular advantage of the inventions is that they may be relatively easily used in spaces that are generally small and cramped and are typically filled with equipment of various types and configurations. Telephone and local area network (LAN) rooms are usually kept as small as possible, and space in such rooms is at a premium. Racks are often installed several feet away from a wall, to allow space for the technician to access the rear. The invention, however, allows for rack installation directly adjacent to a wall, and in other tight areas, saving and maximizing space. Efficient use of space is more critical today than historically, since new products in this field are increasing the connection density, i.e., more cables and connections in a given space. The invention allows a user to open an adjustable patch panel in a number of different ways so as to access connections easily even in the smaller spaces allowed by the invention. For example, the user may part the panels of a two-part adjustable patch panel to work behind or inside the front of the rack or behind at least part of the adjustable patch panel. As another example, the user may pull open the adjustable patch panel from one side or the other of the rack so as to access the area behind at least part of the adjustable patch panel. The ability to open the adjustable patch panel allows the user to work around existing elements, adjoining equipments, walls or fixtures that may otherwise interfere with working on the rack and its related components or peripherals.

The various embodiments have been described with regard to various elements and features that may be interchanged, added, deleted, as appropriate and as understood by those with the appropriate level of skill in the art. The inventions are not to be limited to the described embodiments.

### BRIEF DESCRIPTION OF THE DRAWINGS

FIGS. 1A and 1B illustrate front views of an exemplary embodiment of the inventions.

FIGS. 2A and 2B illustrate perspective views of exemplary embodiments of the inventions.

FIGS. 3A and 3B show a front perspective view and a back perspective view of an exemplary embodiment according to the inventions.

FIGS. 4A and 4B show front perspective views of two configurations of an exemplary embodiment according to the inventions.

FIG. 5 illustrates a front perspective view of an exemplary embodiment of the inventions.

### DESCRIPTION

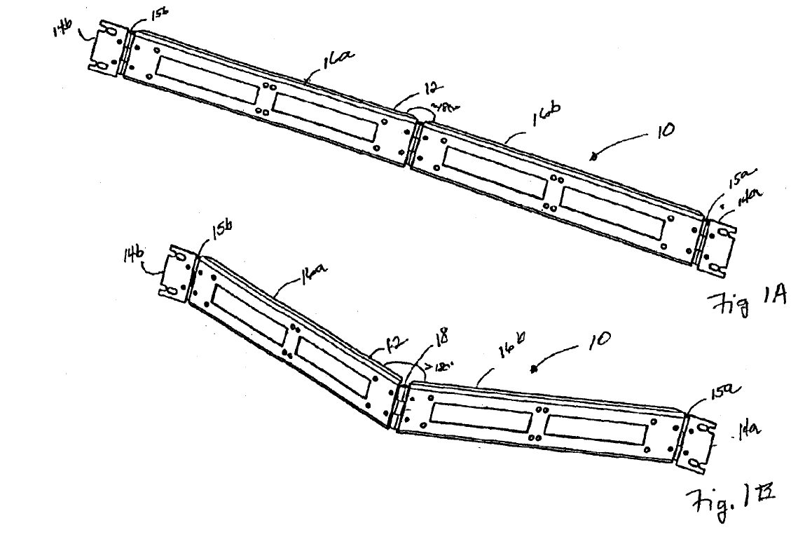

FIGS. 1A and 1B illustrate an adjustable patch panel and methods of using same according to an exemplary embodiment of the invention. In particular, FIGS. 1A and 1B show how the same patch panel may be adjusted to fit racks of different sizes. FIG. 1A shows an exemplary adjustable patch panel 10 that may be made to fit a rack of a first size. FIG. 1B shows the same exemplary patch panel 10 as it may be adjusted to fit a rack of a second size, where the first sized rack is wider than the second sized rack. Either the first or the second sized rack, or both, may be of respective standard rack widths (also referred to as sizes) (currently 23 inches and 19 inches per the Electronic Industries Association (EIA). Also, the exemplary adjustable patch panel 10 may be made to fit racks of other sizes. No other part(s) are necessary to make the adjustment of a patch panel to fit one or another of a particular size rack.

Reference is made herein generally to the inventions being made to fit or mount “racks” such as network equipment racks and distribution frame racks, but the inventions should not be limited to racks when the inventions may be used with other elements, devices, and/or systems.

The exemplary adjustable patch panel 10 may include panels (also referred to as “arms) that may be separately opened (in part or almost completely) and/or opened from one side or the other so as to facilitate access to areas behind the patch panel and operations with respect to the rack, cable connectors, etc. For example, one or both panels of the patch panel 10 may be opened easily from the front to allow rear wiring access.

The exemplary adjustable patch panel 10 may include openings (also referred to as “ports”) for one or more cable connectors that may be used to receive cabling on the front side and the rear side of the adjustable patch panel. Each connector may have a horizontal axis. A cable connector also may be referred to as a “connector”, a “cabling connector” and “jack”. Different configurations for the cable connectors may be used with the inventions.

In particular, the exemplary adjustable patch panel 10 may include a panel frame 12. It should be noted that the “panel frame 12” is not a separate element but is made up of panels 16a, 16b in this example. As shown in FIGS. 1A and 1B, the panel frame 12 may be configured as a generally relatively wide (with respect to height) rectangle. Other embodiments of the adjustable patch panel 10 may include panel frames and other elements that may be sized and shaped differently than in the described and illustrated embodiments. For example, an alternative adjustable patch panel may be rectangular, but relatively tall compared to its width. The adjustable patch panel may be made to fit racks of varying sizes and shapes.

Referring again to the exemplary adjustable patch panel 10 illustrated in FIGS. 1A and 1B, as noted, the exemplary adjustable patch panel 10 includes a panel frame 12 and optional mounting plates 14a, 14b. A mounting plate may be referred to as a “mounting means”, or “mounting element”. The optional mounting plates 14a, 14b may be of any appropriate size, shape, or material to fit their function. The optional mounting plates 14a, 14b may be provided on opposite longitudinal ends (also referred to as the “sides”) of the panel frame 12, or otherwise, so as to allow the exemplary adjustable patch panel 10 to be readily mounted to a rack. In the exemplary embodiment illustrated, each of the optional mounting plates 14a, 14b is attached to the panel frame 12 by a connector 15a, 15b such as a hinge (which may be made of any appropriate material), and/or other sufficiently flexible material (or combination of material) such as leather, rubber, or plastic. A “connector” may be referred to herein as an “end connector”, “mounting means hinge”.

Alternatively, the optional mounting plates 14a, 14b may be directly connected to the panel frame 12 at respective opposite longitudinal ends of the panel frame 12 or otherwise. As yet another alternative, the optional mounting plates 14a, 14b (or similar elements) may be positioned (with or without connectors 15a, 15b) other than at opposite longitudinal ends of the panel frame 12. Two mounting plates 14a, 14b are illustrated in FIGS. 1A and 1B, but only a single mounting plate (either 14a or 14b) may be used in an alternative embodiment, or more than two mounting plates similar to 14a, 14b may be used. Further, another exemplary embodiment may fail to include any mounting plates such as illustrated or otherwise, but may allow for the positioning of the adjustable patch panel 10, and particularly, the panel frame 12, in another manner with respect to a rack and/or other patch panels.

In the embodiment illustrated in FIGS. 1A and 1B, the adjustable patch panel 10 has a panel frame 12, which includes two panels 16a, 16b of approximately the same size. Each of the panels 16a, 16b is generally rectangular, being more than twice as wide as it is high. In alternative embodiments, the panels may take on other shapes and sizes as appropriate to the particular adjustable patch panel and its intended used with a particular rack. Each of the panels 16a, 16b includes one or more openings to receive one or more modules including a plurality of cable connectors (also referred to as cable connector modules) that are sized to fit within the openings preferably by snap fit. Rather than replaceable modules, however, the modules may be integrated into a panel 16a, 16b.

In the exemplary embodiment, the panels 16a, 16b are joined by a device 18 such as a hinge or flexible material (such as leather, rubber, or plastic) that allows for the adjustable patch panel 10 to be positioned so as to fit (at least) a rack of a first size and also to be positioned to fit a rack of a second size. For example, the exemplary adjustable patch panel 10 as illustrated in FIG. 1A fits a rack of a first size by the generally collinear positioning of the two panels 16a, 16b so that they have a common horizontal axis. This collinear positioning of the two panels 16a, 16b adjusts the exemplary patch panel 10 to its widest position so as to fit the rack of a first size.

To fit a rack of a second (less wide) size, the exemplary adjustable patch panel 10 may be configured so that its panels 16a, 16b form an exaggerated “V” shape (with the bottom or “point” of the “V” away from the rack). The device 18 allows the two panels 16a, 16b to selectably change their positions with respect to each other so that the inside angle between the two panels 16a, 16b may change from 180 degrees in its widest position (see previous paragraph) to less than 180 degrees as illustrated in FIG. 1B. Thus, the adjustable patch panel 10 as illustrated in FIG. 1B fits a rack that is less wide than the rack upon which the adjustable patch panel 10 as illustrated in FIG. 1A may be installed. The device 18 may be a hinge (which may be made of any appropriate material), and/or other sufficiently flexible material (or combination of material) such as leather, rubber, or plastic.

FIGS. 1A and 1B show that the exemplary adjustable patch panel 10 may be positioned to fit racks of two different sizes. The same exemplary adjustable patch panel 10 may be made to fit racks of other sizes as well by adjusting the position of the two panels 16a, 16b with respect to each other. In the exemplary embodiment, this adjustment is allowed by the device 18, which may be a hinge or otherwise. For example, for easy transport, the exemplary adjustable patch panel 10 may be folded so that the two panels 16a, 16b lie parallel to each other with the angle being effectively 0 degrees between them at the device 18.

The exemplary adjustable patch panel 10 as illustrated in FIGS. 1A and 1B may be composed of the seven (7) separate elements: (1) the device 18, (2)-(3) the two panels 16a, 16b; (4)-(5) the connectors 15a, 15b; and (6)-(7) the optional mounting plates 14a, 14b. Each of these seven (7) separate elements may be made of a different material(s); alternatively, like elements may be made of the like material(s) with respect to each other. As yet another alternative, all of the elements may be made of the same material(s). Moreover, all of the elements may be integrally made, or a group(s) of the elements may be integrally made with other element(s) separately made. For example, the device 18 may be integrally made with the two panels 16a, 16b so as to constitute an “integral piece”. In this example, the connectors 15a, 15b as well as the mounting plates 14a, 14b may be each separate pieces. The separate connectors 15a, 15b connect, respectively, the separately mounting plates 14a, 14b to the integral piece.

The exemplary adjustable patch panel or elements thereof may be made of any suitable material(s) such as sturdy or rigid materials such as steel, aluminum, plastics or carbon fiber composite, etc.

As noted, the adjustable patch panel 10 shown in FIGS. 1A and 1B includes a panel frame 12 with two panels 16a, 16b joined by a device 18 such as a hinge. The invention, however, should not be limited to this single embodiment. For example, the two panels 16a, 16b need not necessarily be of the same approximate size. One panel might be wider than the other, and/or be otherwise different. Another alternative embodiment of the invention may include a panel frame with three or more panels, where each two adjacent panels of the three panels of the alternative embodiment may be joined by a device such as a hinge. Such an alternative embodiment with three panels in its panel frame may have the center panel joined by two devices, respectively, to the two side panels. The adjustable patch panel of this alternative embodiment may be fitted to racks of various sizes. For example, the three panels of the panel frame of this alternative embodiment may be collinearly aligned as allowed by the devices so as to fit a relatively wide rack, or the three panels may be configured into a general “U” shape as allowed by the devices so as to fit a rack that is less wide. It may be that this alternative embodiment may be made to fit racks of sizes between the relatively wide rack, and the rack that is less wide. The three panels of this alternative embodiment do not necessarily have to be of the same size or shape or other configuration.

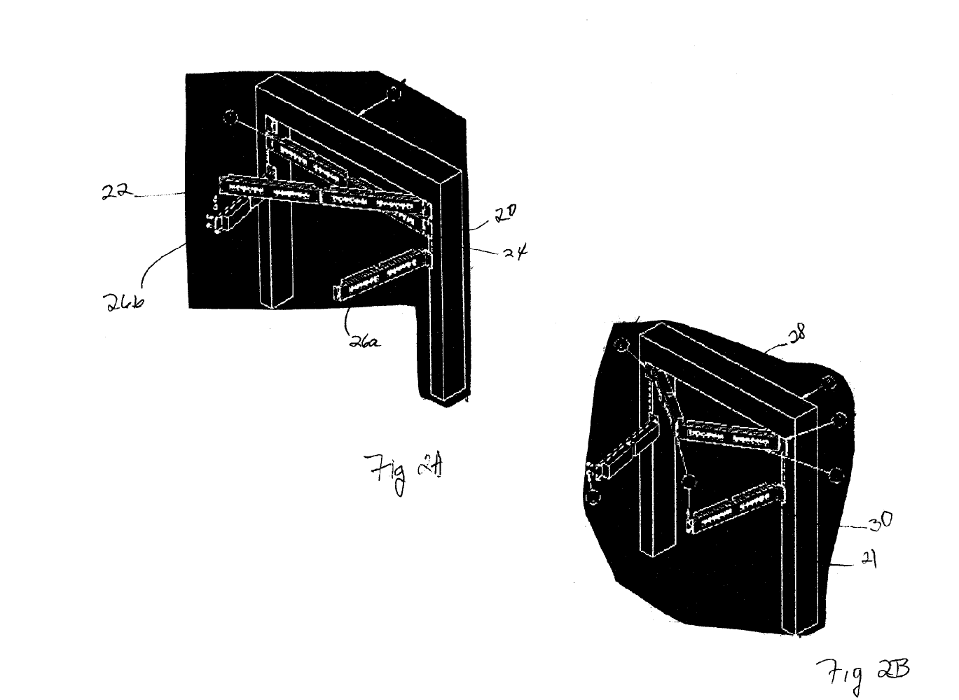

FIGS. 2A and 2B illustrate how exemplary embodiments of the inventions similar to that described above in connection with FIGS. 1A and 1B might be used in different ways with a rack 20 (both shown in part).

FIG. 2A shows three exemplary embodiments 22, 24, and 26A-B as may be mounted or used in three different ways with rack 20. The top embodiment 22 is a patch panel including two panels or arms connected in a collinear fashion. The top embodiment 22 is mounted on its right side to the rack 20. There is a flexible connection between the right panel of the top embodiment 22 and its mounting plate. The flexible connection (such as a hinge) allows the two panels to be pivoted around the vertical axis of the flexible connection. As shown, the patch panel 22 is pulled away from its open end (left side), which allows a user to access the back of the patch panel 22 and/or may facilitate access to other nearby areas.

The middle embodiment 24 is a similar patch panel to the top embodiment 22. The two panels of the middle embodiment 24 are collinearly positioned similar to those of the top embodiment 22. The middle embodiment 24, however, is shown as mounted at both ends to the rack 20. Thus, the middle embodiment 24 may be considered to be in a “closed” position.

Like the top embodiment 22, the bottom embodiment 26A,B is shown in a way in which a user may gain access to the back of that panel and/or nearby areas. The bottom embodiment 26A,B is like the middle embodiment 24 in that both of the bottom embodiment's ends have been mounted to the rack 20. The two panels 26A, 26B making up the bottom panel have been opened or pulled apart from each other so as to gain access to the back of them and/or nearby areas. The opening of the panels 26A, 26B is made possible by the disconnection of the releasable connection between the panels 26A, 26B. In this example, the screws of the hinge connecting the two panels of the bottom embodiment have been removed to disconnect the two panels. The center hinge may be configured as a breakaway hinge or otherwise so that the two panels may be separated from each other even while the exemplary adjustable patch panel is mounted in place. In the illustrated embodiment, the center hinge is attached with fasteners (screws) which may be removed as needed and re-assembled, allowing the left and right panels of the exemplary adjustable patch panel to rotate outward away from each other. In this configuration with the left and right panels rotated away from each other, the user may readily access rear connections even though the user may be positioned in front of the rack.

FIG. 2B shows two exemplary embodiments 28, 30 that compare to the above embodiments 22, 24, and 26A-B. The rack 21, in FIG. 2B, is less wide or narrower than rack 20 in FIG. 2A. Advantageously, the same adjustable panel may be used with the rack 21 of FIG. 2B as that of rack 20 of FIG. 2A. To accommodate the more narrow rack 21, the top embodiment 28 in FIG. 2B is fit to the rack 21 so that the top embodiment 28 assumes an exaggerated “V” shape. This shape is achieved by the flexibility of the connection between the panels of that top embodiment 28. FIG. 2B also shows another patch panel 30. This illustration shows that the connection that allows for the “V” shape in an exemplary patch panel may be disconnected so that the panels or arms of the patch panel 30 may be opened for access to the back or nearby areas.

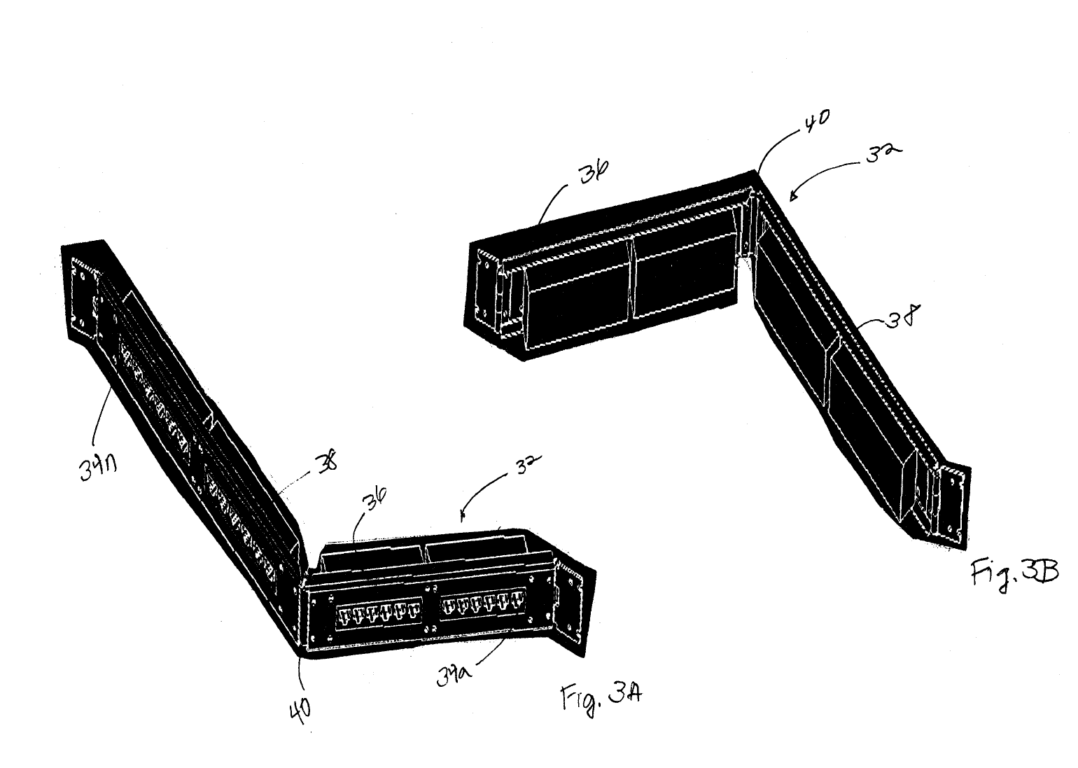

FIGS. 3A and 3B illustrate, respectively, a front perspective view and a back perspective view of another alternative exemplary embodiment 32 according to the inventions. This alternative embodiment 32 is shown with cabling connectors 34a-34 n included. Also, this alternative embodiment includes two panels 36, 38 with one of the panels 38 being wider than the other panel 36. Both panels 36, 38 include two sets of cabling connectors, but the wider panel includes two sets of cabling connectors with each set being wider than a set of the two sets of cabling connectors in the less wide panel. In this alternative embodiment, each unit of the two sets of cabling connectors in each panel is of approximately the same size, but this does not have to be the case and may vary from embodiment to embodiment.

Also in the example illustrated in FIGS. 3A and 3B, the panels of the exemplary adjustable patch panel 32 are joined by a flexible material 40 such as rubber, plastic, leather, or the like. The flexible connection between the panels of this exemplary adjustable patch panel 32 allows the patch panel 32 to be positioned in a variety of ways so as to accommodate racks of varying sizes, particularly of varying widths. The flexible connection is illustrated in FIGS. 3A and 3B as running the entire height of the respective inner sides of the panels of the exemplary adjustable patch panel 32 and to appear as if the flexible connection is a single piece, element, or device. Nonetheless, the flexible connection may be made by more than a single piece, element, or device, and does not necessarily have to run the entire height of the respective inner sides. In some cases, the flexible connection may be less than, or even greater than the height of the respective inner sides of the panels of the patch panel.

A feature that may be included with the exemplary adjustable patch panel 32 illustrated in FIGS. 3A and 3B is a “disconnection” feature that allows the panels to be separated from each other so that they may be swung open to allow access to the back of the patch panel, the inside of the rack, etc. Screws or other fasteners may be used to create or enforce the flexible connection between the panels, and the screws or other fasteners may be removable to allow for opening of the panels 36, 38. The movement of the panels away from each other may be further facilitated by the inclusion of hinges, flexible material, or other devices that allow each panel to swing with respect to a pivot point on its respective side of the rack to which the panels are mounted. In some cases, the panels may be made to swing away from each other in a direction outwards or away from the rack and/or inwards or towards the rack.

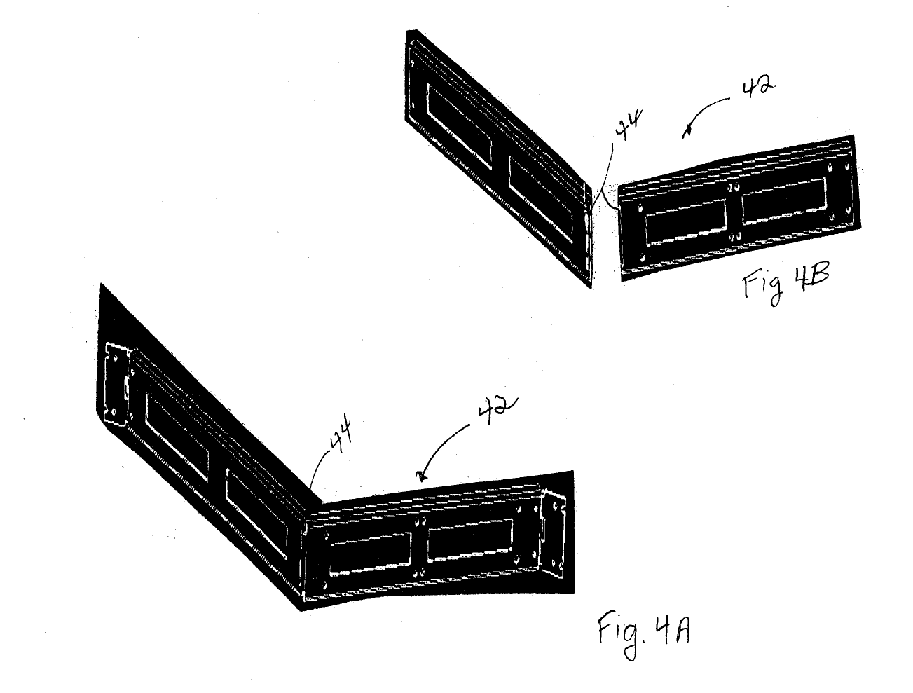

FIGS. 4A and 4B illustrate yet another exemplary embodiment 42 of the inventions. This alternative includes a device that connects the panels of the patch panel so that (1) the patch panel may fit a variety of sized racks and (2) the panels may be disconnected moved so as to allow access to the areas behind the panels. The connection/disconnection device 44 may include “hook and eye” feature(s) so that when the panels are fit together, the hook and eye feature(s) form a rotational joint, allowing the patch panel to be adjustability fit or positioned with respect to a rack. Other device(s) that may or may not include hook and eye feature may be used in place of the referenced device including a hook tab/slot configuration, a gate hook/eye type of element, or otherwise. FIG. 4A shows the exemplary embodiment in its connected state, and includes optional mounting plates. FIG. 4B shows the exemplary embodiment in its disconnected state without optional mounting plates.

Another advantage of the alternative embodiment of FIGS. 4A and 4B is that it may allow a user with selective access to at least an area behind the patch panel. This selective access may be accomplished by “undoing” the hook and eye features (or otherwise disconnecting the connection/disconnection device) and swinging the panels apart by causing each of the panels to pivot around the hinge (or other connector) that connects the panel to the mounting plate positioned on the rack. Some embodiments may allow the panels to be rotated inwards towards the rack and/or outwards or away the rack. One or more of the panels may swing or be caused to swing more than another one or others of the panels in the patch panel. So, a user may choose to open or close one panel, but not the other.

In addition, the alternative embodiment of FIGS. 4A and 4B illustrates another way in which a user may access an area behind the patch panel. This other way to access an area behind the patch panel 42 is to undo (unscrew, disconnect or otherwise remove) one or the other of the mounting plates used to mount the patch panel 42 to the rack. Once one of the mounting plates is undone, then the panel on the “undone end” of the patch panel 42 may be pivoted around the rotational joint provided by the hook and eye features (and/or other connection/disconnection device) so as to provide access to at least the area behind the undone end of the patch panel.

Further, assume an exemplary adjustable patch panel 42 such as shown in FIGS. 4A and 4B is attached to a rack using two mounting plates that are connected via hinges (or the like) to the outer ends of the two panels of the patch panel 42. Also, assume one of the mounting plates is undone so that one end of the exemplary adjustable patch panel 42 is effectively disconnected from the rack. In that case, most of the entire patch panel 42 may be made to swing away from the rack around the pivot point provided by the hinge (or the like) connecting the still mounted mounting plate to one of the panels of the patch panel 42. By swinging the patch panel 42 away from the rack, the user is provided with access to the area behind the patch panel 42.

The invention also allows for a particular exemplary embodiment of an adjustable patch panel having two panels that are not connected to each other. These unconnected panels may be mounted, respectively, to each side of a rack so that they make up a patch panel. The inner ends of the two panels may be configured so as to fit together so as to allow the patch panel to fit a variety of sized racks. For example, one panel may have an integral hook, opening, dovetail, etc. that fits or compliments the other panel so that the two panels make up a patch panel that may be made to fit a variety of sized racks.

As another example of this particular exemplary embodiment, the inner ends of the two panels may allow the two panels to fit together so that the panels are collinear and the patch panel is at its widest. Yet, the inner ends of the two panels may allow the two panels to rotate with respect to each other so that the inside angle between them is less than the 180 degrees when they are collinear. Rounded inner ends of the panels of the patch panel may allow for this kind of rotation. When the panels are positioned less than 180 degrees with respect to each other, they cause the patch panel to adopt a generally V shape, and consequently, to fit a less wide rack than when the panels are collinear. If a hinge is used to connect each such panel to a mounting plate on respective ends of the patch panel, then one and/or the other of the panels may be rotated so as to allow a user access to at least an area behind the panels of the patch panel. Advantageously, with regard to this particular exemplary embodiment, the end user does not have to unfasten or disconnect or otherwise interact with a device connecting the panels at least because there is no such device in this exemplary adjustable patch panel.

An alternative embodiment to that shown in FIGS. 4A and 4B is similar, but does not have a connection/disconnection device 44. In other words, the panels of this alternative embodiment are not connected to each other. Yet, each panel is flexibly connected to a mounting plate (or other mounting element) so that each panel may rotate or pivot about the vertical axis of the flexible connection. Effectively, each panel is cantilevered in this embodiment. When the panels are closed, the panels assume a collinear position that may be changed by pulling (and/or pushing) one or both of the panels of this alternative embodiment.

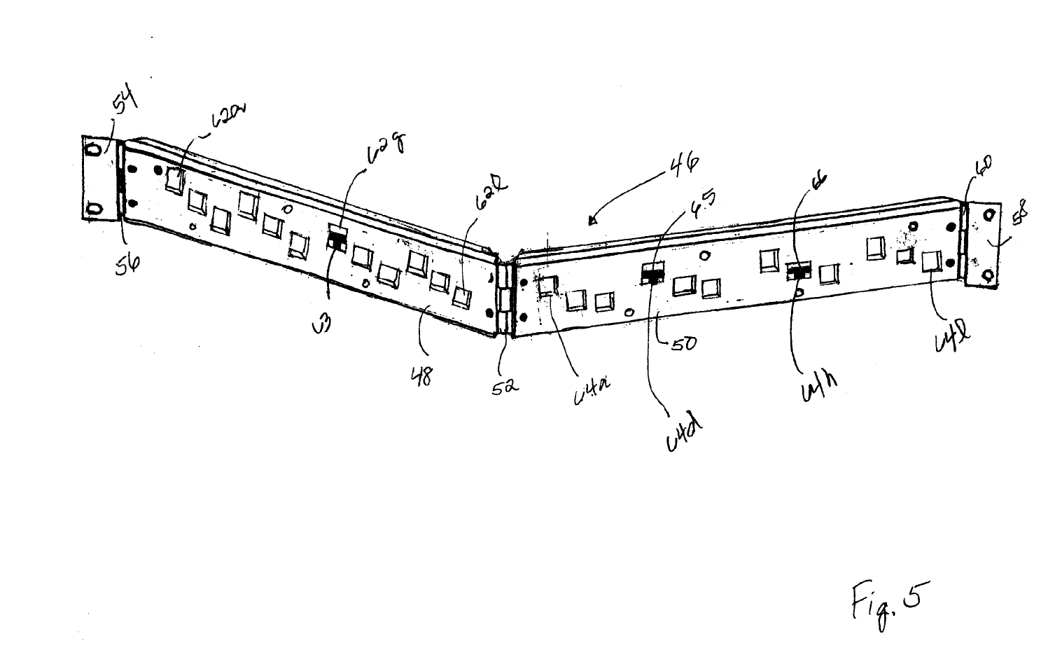

FIG. 5 shows yet another alternative embodiment 46 according to the inventions. Patch panel 46 includes two panels or arms 48, 50 that are releasably and flexibly connected by a connector 52. Panel 48 is connected to mounting plate 54 by flexible connector 56 (which may also be “releasable”). Panel 50 is connected to mounting plate 58 by flexible connector 60 (which may also be “releasable”).

The adjustable patch panel 46 includes openings (also referred to as “ports”) for wiring connectors (also referred to as jacks or snap-in jacks). In particular, panel 48 of patch panel 46 includes 12 openings 62a-621. A jack 63 is shown as fit in opening 62g. Similarly, panel 50 includes 12 openings 64a-641 with a jack 65 shown in opening 64d and another jack 6 shown in opening 64h. Thus, the adjustable patch panel 46 has a 24 port configuration. Other configurations are possible such as a 48 port configuration. Further, the openings 62a-1 and 64a-1 are set in a “staggered” or stepped pattern that allows for easy tracing and neat routing and storage.

With respect to all of the embodiments mentioned, it should be noted only one size in height is shown, but the invention should not be so limited. For example, an adjustable patch panel according to the inventions may have an overall height (or in relevant portions thereof) of 1.75 inches, or multiples thereof, so as to fit generally standard size racks. Other heights may be used as well for different racks, different elements, etc.

The invention has been described with reference to exemplary embodiments that may be used with standard EIA network racks, but the invention should not be so limited, and may be used with any suitable device.

From the foregoing description of the exemplary embodiments of the inventions and operation thereof, other embodiments will suggest themselves to those skilled in the art. Therefore, the scope of the inventions is to be limited only by the claims below and equivalents thereof.

I claim:

1. An adjustable patch panel with back access, comprising:
two panels releasably and flexibly connected to each other in a collinear position to fit a rack of a first size, at least one of the two panels having at least one opening for a cabling connector; and
a mounting means on each panel with each mounting means being flexibly connected to its respective panel,
the flexible connection of each mounting means to its respective panel allowing its respective panel to be selectively pivoted at least partially about a vertical axis of the mounting means, and
the flexible connection of each mounting means to its respective panel allowing adjustment of the flexibly connected panels into a non-collinear position so as to fit a rack of another size,
whereby the flexible connection between the two panels and the flexible connection of each mounting means to its respective panel allows use of the adjustable patch panel with racks of more than one size, and
whereby the releasable connection between the two panels and the flexible connection of each mounting means to its respective panel allows separation of the panels away from each other so as to allow back access to each of the panels.

2. The adjustable patch panel with back access of claim 1, wherein the two panels are releasably and flexibly connected to each other by a connector.

3. The adjustable patch panel with back access of claim 2, wherein the connector comprises a hinge.

4. The adjustable patch panel with back access of claim 1, wherein the mounting means on each panel comprises a mounting plate.

5. The adjustable patch panel with back access of claim 1, wherein each of the mounting means is flexibly connected to its respective panel by a mounting means connector.

6. The adjustable patch panel with back access of claim 1, wherein the mounting means connector comprises a mounting means hinge.

7. The adjustable patch panel with back access of claim 1, wherein each of the panels is substantially the same size as the other panel.

8. The adjustable patch panel with back access of claim 1, wherein the mounting means of each panel is positioned opposite to that panel's connection to the other panel.

9. A patch panel with back access, comprising:
a first arm having at least one opening for a cable connector,
one end of the first arm being attached by an end connector to a mounting plate, the end connector allowing the first arm to swing at least partially and generally perpendicularly about the vertical axis of the end connector; and
a second arm mountable in a position substantially collinear with the first arm by the second arm having an end positionable generally adjacent to an unattached end of the first arm.

10. The patch panel with back access of claim 9, wherein the end connector comprises a first end connector;
wherein the mounting plate comprises a first mounting plate; and
wherein an end of the second arm opposite to the end positionable generally adjacent to the unattached end of the first arm is attached by a second end connector to a second mounting plate, the second end connector allowing the second arm to swing at least partially and generally perpendicularly about the vertical axis of the second end connector.

11. The patch panel with back access of claim 10, wherein the first arm is releasably connected to the second arm

12. The patch panel with back access of claim 10, wherein the first arm is flexibly connected to the second arm so that the arms may be adjusted from the substantially collinear position to another position.

13. The patch panel with back access of claim 12, wherein the patch panel with the arms in the substantially collinear position fits a first size rack; and
wherein the patch panel with the arms in the another position fits a second size rack.

14. An adjustable panel, comprising:
a first arm flexibly connected to a second arm so that the flexibly connected arms are mountable to a rack in a position selected from available positions including a first position where the connected arms are collinear with respect to their horizontal axes, and a second position where the connected arms share a horizontal plane, but are angled with respect to each other;
a first mounting element connected to the first arm opposite to the first arm's flexible connection to the second arm;
a second mounting element connected to the second arm opposite to the second arm's flexible connection to the first arm;
both mounting elements being flexibly connected to their respective arms so as to allow the connected arms to be mounted to the rack in the selected position,
whereby the flexible connection between the first and second arms and the flexible connection of the mounting elements to their respective arms allows the adjustable panel to be mounted in the selected position from the more than one available positions.

15. The adjustable panel of claim 14, wherein the second position comprises the first arm being substantially perpendicularly positioned with respect to the second arm.

16. The adjustable panel of claim 14, wherein the first arm comprises at least one cable connection.

17. The adjustable panel of claim 14, wherein the first arm is releasably and flexibly connected to the second arm so that the first arm is movable away from the second arm.
